(19) United States
(12) Patent Application Publication
(10) Pub. No.: US 2014/0229584 A1
(43) Pub. Date: Aug. 14, 2014

(54) Content Sharing System

(71) Applicants: Hiroyuki Aoki, Kanagawa (JP); Atsuhiko Murayama, Kanagawa (JP)

(72) Inventors: Hiroyuki Aoki, Kanagawa (JP); Atsuhiko Murayama, Kanagawa (JP)

(73) Assignee: NEC CASIO MOBILE COMMUNICATIONS, LTD., Kanagawa (JP)

(21) Appl. No.: 14/346,864

(22) PCT Filed: Aug. 29, 2012
(86) PCT No.: PCT/JP2012/071901

§ 371 Date: Mar. 24, 2014

(30) Foreign Application Priority Data
Sep. 27, 2011 (JP) 2011-210209

(51) Int. Cl. H04L 29/08

(52) U.S. Cl. CPC H04L 67/02
USPC 709/219

(57) ABSTRACT

A content sharing system includes a shared server device and a user terminal device. The shared server device includes: a communication unit that transmits and receives information to and from the user terminal device via a communication line network; a database unit that stores content data serving as a shared content, accompanying information of the content data, and personal information of a user; a control unit that determines whether a processing request is present or not, the processing request relating to processing of information including the content data stored in the database unit; a processing unit that receives and processes the processing request from the control unit when the processing request is present; and a plurality of dependent processing units that belong to the processing unit and execute processing corresponding to the processing request. The user terminal device includes: a transmission and reception unit that transmits and receives information to and from the shared server device via the communication network; a terminal input unit that receives input of a processing request relating to the content data; a terminal control unit that creates a command, transmits the command to the shared server device via the transmission and reception unit and creates display data when a processing request relating to the content data is present, the command corresponding to the processing request, the display data including the content data and related data of the content data; and a terminal display unit that displays the display data created by the terminal control unit.

### TECHNICAL FIELD

The present invention relates to a content sharing system. The present invention, in particular, relates to a content sharing system that permits other users who exist within a predetermined fixed range from a location where content is registered or are near thereto to browse and download within a predetermined availability period.

### BACKGROUND ART

In recent years, a content sharing system has been developed that enables the mutual browsing and downloading of content data. In this content sharing system, by registering content data created by user terminal devices with a content server, that data is shared with other specified user terminal devices. By using such a content sharing system, for example, sharing of content related to a specified location (for example, image data of that specification location) among a plurality of users who have visited the specified location, and mutual browsing and downloading of that content become possible. By communal viewing of this content among specified users, it becomes possible to understand the surroundings, including the atmosphere and the like of the surroundings, that is difficult to transmit by electronic data that is based on text data. Thereby, it is possible to further deepen the mutual understanding and cooperation of users.

As publicly known art of this field, for example, Patent Document 1 discloses an information processing system that is capable of automatically changing the use conditions of a service, without burdening an operator. Specifically, in Patent Document 1 is disclosed a storage information management method in an online service system that stores data in an information processing device connected to a network. This management method moves image data from a first image data storage area to a second image data storage area, calculates the data quantity of the image data, and then changes the storage information of the image data when moving the image data according to the calculated data quantity.

For example, in Patent Document 2, art is disclosed to distribute and use content which have, for example, higher convenience, higher entertainment, and are more useful than ever before.

Specifically, the header structure is common among content files with different formats. In this header is stored information in which relations to other content regarding the creation intention of the creator is indicated, such as information showing a content file used for creating the content, or answer content and the like. In the case of retrieving content related to one content, the aforementioned information is used. Thereby, retrieval is performed centered on the generation of content, and retrieval of content is performed centered on the creator's creation intention.

For example, art that can enable a person other than a content creator to easily discover a target content from shared resources is disclosed in Patent Document 3. Specifically, when a server receives an image and classification information from a camera, the classification information is collated with classification information attached to image(s) (one or a plurality) registered in an image database with respect to each coincident item to determine the matching degree thereof. For example, when the classification name matches, the subject name matches, the subject location matches, or the shooting location matches a search keyword, directory information of a storage directory of an image corresponding to classification information including the classification name, the subject name or the shooting location is determined as storage destination candidate information. The server transmits the determined storage destination candidate information to the camera.

For example, art that enables the provision of registered information to a user, without being restricted by location, is disclosed in Patent Document 4. Specifically, a recognizer recognizes a category from an image of a target object acquired by a user with a terminal device. A server transmits the recognized category to the terminal device, and receives a category “fixed-line phone” selected by the user, and additional information corresponding thereto. An information database registers the additional information in correspondence with the recognizer of the “fixed-line phone.” Thereafter, the recognizer recognizes a category from an image of a target object acquired by a user with the terminal device. The server, upon recognizing the category “fixed-line phone” from the image of the target object, acquires additional information registered in the information database, and transmits it to the terminal device. The invention disclosed in Patent Document 4 can be applied to, for example, information providing systems.

For example, art is disclosed in Patent Document 5 that enables construction of a community with actual connections by sharing an image (photograph) between a plurality of users through a network. Specifically, display terminals, when transmitting an image to an image accumulation/distribution server, transmit the installation position information of the terminal and shooting position information of the image appended thereto. The image accumulation/distribution server accumulates images from the display device group and the installation position information and shooting position information appended to the images by associating them with each other. The image accumulation/distribution server defines the installation position of the display device or the shooting position of the image as retrieval conditions, and selects the image whose installation position or shooting position are almost the same as the retrieval conditions from among the plurality of accumulated images, and transmits it to the terminal devices of the display devices. The display devices receive and store the image transmitted from the image accumulation/distribution server.

### PRIOR ART DOCUMENTS

### Patent Document

### [Patent Document 1] Japanese Unexamined Patent Application, Fist Publication No. 2005-049933

### [Patent Document 2] Japanese Unexamined Patent Application, Fist Publication No. 2009-245178

### [Patent Document 3] Japanese Unexamined Patent Application, Fist Publication No. 2010-079788

### [Patent Document 4] Japanese Unexamined Patent Application, Fist Publication No. 2011-039647

### [Patent Document 5] Japanese Unexamined Patent Application, Fist Publication No.

### SUMMARY OF THE INVENTION

### Problem to be Solved by the Invention

However, in the publicly known content sharing systems described above, the validity of the registered content data is not evaluated. This problem is generally seen in databases including the art disclosed in Patent Documents 1 to 5 mentioned above. There is the problem of expired content data remaining registered as is. That is to say, the publicly known content sharing systems are incapable of judging the usefulness of registered information. Also, since information that is once registered is retained until being deleted by a user operation, old information and new information become mixed. For this reason, there is the problem of increasing the reliability of the registered information as a whole being difficult.

Also, there is the problem of content data that is not necessarily of use to the user, and content data of little necessity being sent unilaterally from a shared server. In this case, the content data that was sent is outdated and troublesome for the user. Not only that, but the system is burdened with a wasteful processing load. Moreover, the problem also arises of content data truly useful to the user being overlooked. Also, when the number of content data registered with a shared server device increases, there is the problem of the browsability and retrievability becoming worse.

Whether or not content data is useful to the present user is often determined by the relationship between the location at which that content data was gathered, and the current position of that user. However, the publicly known content sharing systems do not take that aforementioned positional relation into consideration. Accordingly, even if the user receives the content data, depending on the present position of that user, there is the problem of that content data being outdated, or the case occurring of not being of use to subsequent actions of the user.

The art disclosed in Patent Document 3 is an invention relating to a content management device that classifies content, attaches a directory name to each type, and separately stores the respective directories, and differs in the scope of rights and content of the present invention.

An exemplary object of the present invention is to provide a content sharing system that solves the aforementioned issues.

### Means for Solving the Problem

In order to solve the aforementioned issues, a content sharing system according to an exemplary aspect of the present invention includes a shared server device and a user terminal device. The shared server device includes: a communication unit that transmits and receives information to and from the user terminal device via a communication line network; a database unit that stores content data serving as a shared content, accompanying information of the content data, and personal information of a user; a control unit that determines whether a processing request is present or not, the processing request relating to processing of information including the content data stored in the database unit; a processing unit that receives and processes the processing request from the control unit when the processing request is present; and a plurality of dependent processing units that belong to the processing unit and execute processing corresponding to the processing request. The user terminal device includes: a transmission and reception unit that transmits and receives information to and from the shared server device via the communication network; a terminal input unit that receives input of a processing request relating to the content data; a terminal control unit that creates a command, transmits the command to the shared server device via the transmission and reception unit and creates display data when a processing request relating to the content data is present, the command corresponding to the processing request, the display data including the content data and related data of the content data; and a terminal display unit that displays the display data created by the terminal control unit.

### Effect of the Invention

As described above, the content sharing system of the present invention has an effect of being able to increase the reliability of the entire content data that is registered with the shared server device.

### BRIEF DESCRIPTION OF THE DRAWINGS

FIG. 1 is a configuration diagram that shows the entire constitution of a content sharing system according to an exemplary embodiment of the present invention.

FIG. 2 is an explanatory diagram that shows one example of content data to be registered.

FIG. 3 is an explanatory diagram that shows one example of “content notification desire/setting data” included in a command that is sent from a user terminal device to a shared server device shown in FIG. 1.

FIG. 4 is an explanatory diagram that shows one example of user information that is registered in the shared server device shown in FIG. 1.

FIG. 5 is a flowchart that shows the operation sequence of the user terminal device shown in FIG. 1.

FIG. 6 is a flowchart that shows the operation sequence of the shared server device shown in FIG. 1.

### EMBODIMENTS FOR CARRYING OUT THE INVENTION

A content sharing system according to an exemplary embodiment of the present invention, when registering a content data, organizes and accumulates a content data that becomes a shared content, and accompanying information of the content data in a shared server device. In the accompanying information of the content data are included at least the type, registration time and date, registration position information (position information of the location where the content data was gathered and registered), content ID information, creator ID information, availability period, range of release, browsable time slot, and number of times browsed.

After this, the content sharing system, with that registered location serving as a basis, permits other users who exist within a predetermined fixed range from that location or are near thereto to browse and download within a predetermined availability period.

Constituting it in this manner enables browsing within a predetermined availability period for other users who exist within the predetermined fixed range or are near thereto, or other users who visit a location within the same range after the point in time of registration of the content data. Also, by constituting it in this manner, users who have acquired the content data can browse the content data while experiencing with their own five senses the atmosphere and the like of the location where the content data was gathered along with the content data. Thereby, sense-related sharing between users becomes possible. As a result, it is possible to further deepen the degree of mutual coordination among a specified plurality of users.

More specifically, a content data that is shared by being registered with a shared server device is a content data that a user has created in a particular location (for example, image data or the like that was shot by a camera). This content data is registered with the shared server device together with accompanying information. This accompanying information may for example be registration position information, content ID information, creator ID information, or the like. Hereinbelow, a content sharing systems according to an exemplary embodiment of the present invention shall be described in detail referring to the drawings.

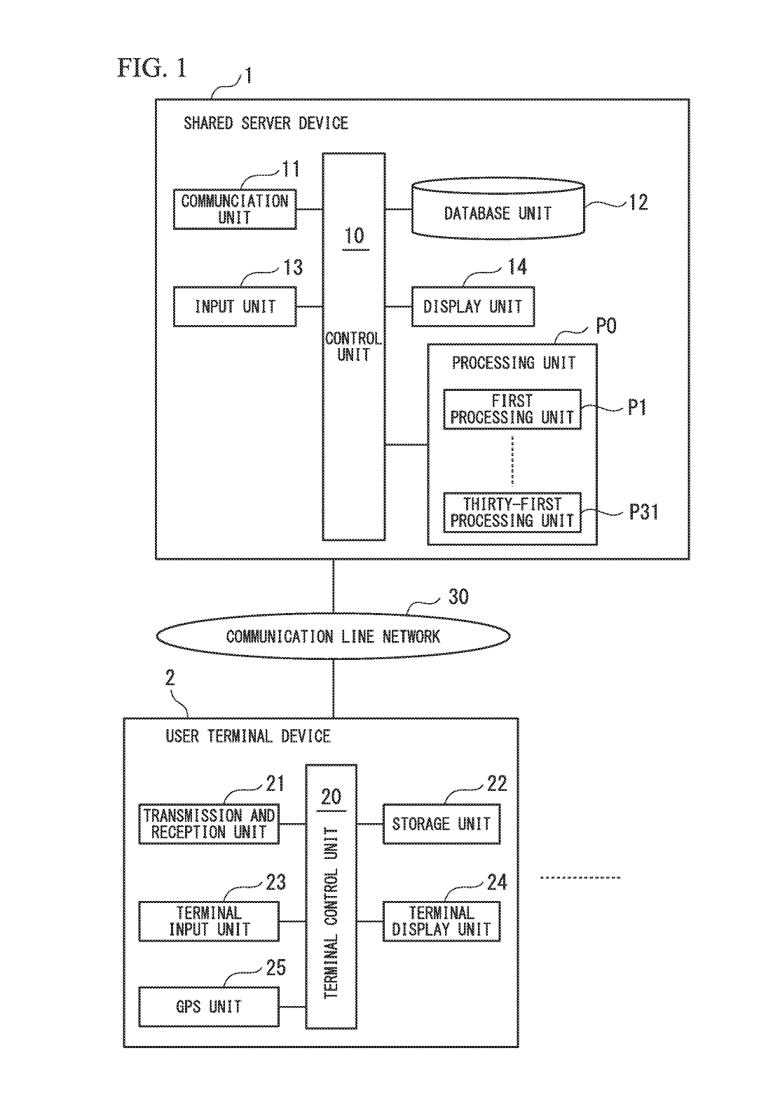

FIG. 1 is a diagram that shows the entire constitution of a content sharing system according to the exemplary embodiment of the present invention. This content sharing system includes a shared server device 1 that registers content data and retrieves registered content data according to conditions, and a communication line network 30 that connects the shared server device 1 and individual user terminal devices 2 to be able to communicate.

The shared server device 1 includes a control unit 10, a communication unit 11, a database unit 12, an input unit 13, a display unit 14, a processing unit P0, and a first processing unit P1 to thirty-first processing unit P31 (a plurality of dependent processing units). The control unit 10 controls the entirety. The communication unit 11 includes a protocol that enables communication via the plurality of user terminal devices 2 and the communication line network 30. The database unit 12 stores registered content data. The input unit 13 inputs commands and data of the manager. The display unit 14 performs display of information and data for the manager. The processing unit P0 performs processing including retrieval of registered content data in accordance with requests from the plurality of user terminal devices 2. The first processing unit P1 to thirty-first processing unit P31 belong to the processing unit P0.

Each of the plurality of user terminal devices 2 includes a CPU 20, a transmission and reception unit 21, a storage unit 22, a terminal input unit 23, a terminal display unit 24, and a GPS (global positioning system) unit 25. The CPU 20 creates a command that indicates a request to the shared server device 1, and controls the entire user terminal device 2. The transmission and reception unit 21 includes a protocol that enables communication via the communication line network 30 with the shared server device 1. The storage unit 22 stores content data and the like that has been downloaded. The terminal input unit 23 inputs commands and data of the user. The terminal display unit 24 performs display of information and data for the user. The GPS unit 25 always acquires the existence position (position information) of itself (the user terminal device 2).

The user terminal device 2 may be a mobile telephone device, a mobile terminal device, or a game device. The communication line network 30 may include a mobile telephone line network, a public communication line network, a wireless communication network, the Internet, a LAN or the like.

Hereinbelow, the functions of the content sharing system according to the present exemplary embodiment shall be described. A content data to be registered is transmitted to the shared server device 1 via the user terminal device 2 and the like. The shared server device 1 registers the content data by storing it in the database unit 12. A user who desires browsing or saving of content data notifies to the shared server device 1 the position information of the user terminal device 2 he himself is carrying, user information, and setting data for retrieving the desired content data (here, content notification desire/setting data). The user terminal device 2 receives a list of browsable content data from the shared server device 1, and, by selecting and designating content data, browses or downloads and saves the data.

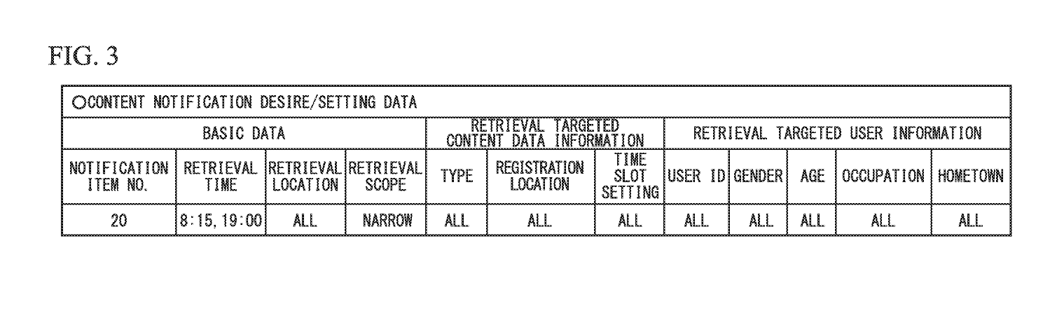

Automatic notification from the user terminal device 2, automatic reception of the aforementioned notification in the shared server device 1, and processing by voluntary judgment by the shared server device 1 are the basic processing operations. However, a processing operation is also performed for the case of the shared server device 1 having received a command created based on a user operation from the user terminal device 2. When creating a command based on a user operation from the user terminal device 2, each user terminal device 2 creates a command that indicates a request to the shared server device 1 in accordance with each of the user commands input via the terminal input unit 23, and transmits that command to the shared server device 1 via the transmission and reception unit 21. In the case of a command relating to browsing or downloading of content data, the “content notification desire/setting data” shown in FIG. 3 is also included in that command.

The user can transmit one or more commands to the shared server device 1 via the user terminal device 2. Verification of whether or not these commands are mutually conflicting is the user's responsibility. The shared server device 1, in the case of there existing a processing request that should be processed by voluntary judgment, or in the case of having received a processing request by one or more commands from the user terminal device 2, delivers the processing request to the processing unit P0. The processing unit P0 classifies the processing request according to function, and assigns it to the first processing unit P1 to thirty-first processing unit P31. Each of the first processing unit P1 to thirty-first processing unit P31 simultaneously executes the processing request that has been assigned in sequence, or simultaneously with other processing units.

Next, the shared server device 1 receives from the processing unit P0 the processing result that was processed by the first processing unit P1 to thirty-first processing unit P31, and replies to the user terminal device 2 that is the command originator via the transmission unit 11. Even without a user command being input via the terminal input unit 23, the user terminal device 2, in the case of the internal state of the device fulfilling the condition of a predetermined processing request that should be processed, automatically creates a command, and transmits it to the shared server device 1. The shared server device 1 receives this command, and performs the processing in the same manner as mentioned above.

The user terminal device 2 always transmits its own location (position information) that is always acquired via the GPS unit 25 to the shared server device 1. The shared server device 1 thereby always grasps the location (position information) of the user terminal device 2. The location (position information) of the user terminal device 2, as described above, is notified to the shared server device 1 also during command transmission from the user terminal device 2.

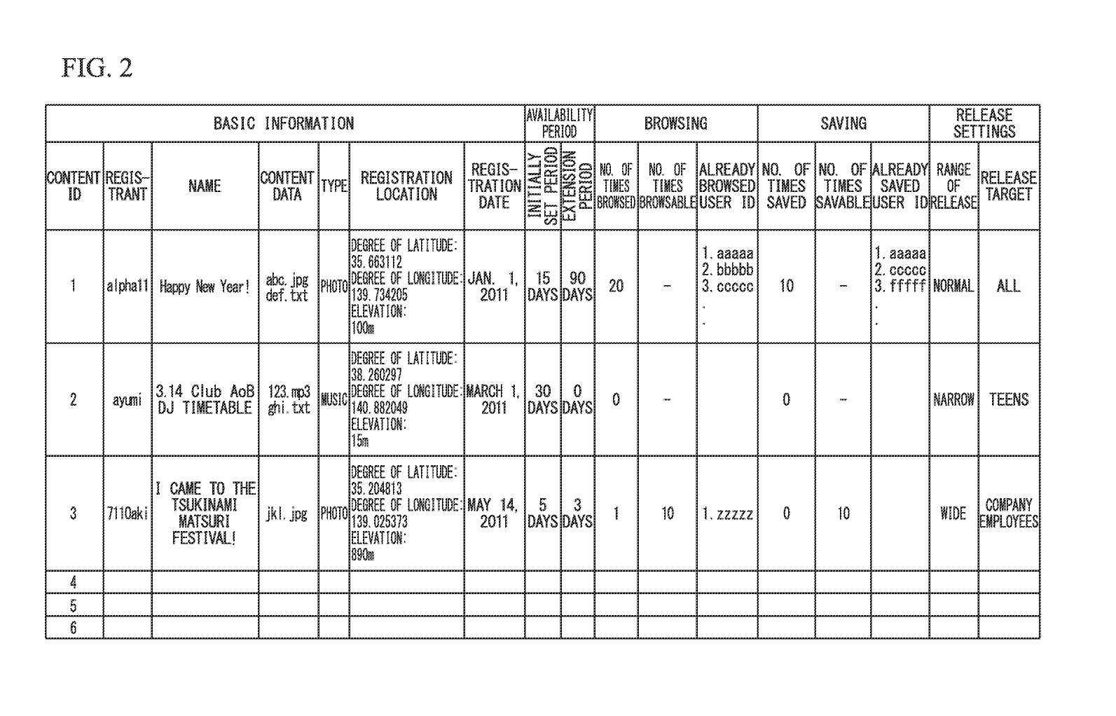

FIG. 2 is an explanatory diagram that shows an example of content data to be registered. In the content data that are illustrated in FIG. 2, “Content ID”, “Registrant”, “Name”, “Content Data”, “Type”, “Registration Location”, and “Registration Date” are set as data items to be registered for basic information. “Initially Set Period” and “Extension Period” are set as the availability period. “No. of Times Browsed”, “No. of Times Browsable”, and “Already Browsed User ID” are set as the browsing information. “No. of Times Saved”, “No. of Times Savable” and “Already Saved User ID” are set as the information related to saving. “Range of Release” and “Release Target” are set as the settings information related to release.

FIG. 3 is an explanatory diagram that shows one example of the “content notification desire/setting data” included in a command. In the “Content Notification Desire/Setting Data” illustrated in FIG. 3, “Notification Item No.”, “Retrieval Time”, “Retrieval Location”, and “Retrieval Scope” are set in the basic information (basic data) as the data items. “Type”, “Registration Location”, and “Time Slot Setting” are set as information showing the retrieval targeted content data. “User ID”, “Gender”, “Age”, “Occupation”, and “Hometown” are set as retrieval targeted user information.

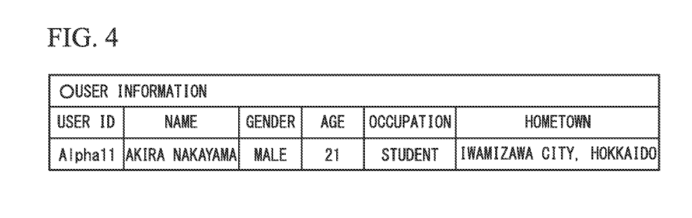

FIG. 4 is an explanatory diagram that shows one example of user information that is registered. In the user information that is illustrated in FIG. 4, “User ID”, “Name”, “Gender”, “Age”, “Occupation”, and “Hometown” are set as the data items.

Hereinbelow, the functions of the content sharing system of the present exemplary embodiment shall be described in correspondence with the processes of each of the first processing unit P1 to thirty-first processing unit P31 that realize them.

### (Function 1)

Function 1 relates to registration. This function sets a restriction on the availability period with respect to the content to be shared. During registration of a content data with the shared server device 1, the availability period of the content data is initially set to a predetermined period by the shared server device 1.

In this initial setting, the same availability period is set for all of the content data. Thereafter, content data that have passed this availability period becomes unavailable, and is no longer released to users. This function can be realized by the shared server device 1 always monitoring the user terminal devices 2. Alternatively, it is realizable by including in an application for browsing made to be used on the user terminal devices 2 a function that makes unavailable content data that have passed the availability period.

Even content data that the user downloads from the shared server device 1 to the user terminal device 2 he himself carries and saves in the storage unit 22 becomes unavailable upon passing the aforementioned availability period, and so a user can no longer browse it. The user terminal device 2 transmits a request corresponding to this function as a command to the shared server device 1. The shared server device 1 realizes the aforementioned function by executing by the first processing unit P1 the process that has been commanded. By being configured in this manner, it is possible to prevent undesirable effects (for example, the database becoming outdated, and lowering of the quality of service) due to information whose discordance with the present situation is great (old information) going into circulation.

### (Function 2)

Function 2 relates to extension of the availability period of a content data. This function extends the period during which it is possible to use a content data in accordance with the number of times that the content data has been browsed. The availability period is initially set for a content data as shown in FIG. 2. When that availability period is passed, that content data becomes no longer available. However, in the case of the content data being browsed or downloaded and saved by other users during the period of availability, the shared server device 1 extends the period of availability of the content data by a predetermined fixed period in accordance with the respective number of times of being carried out. Setting is also possible so that the extension period becomes longer for the case of the content data being saved than the case of the content data being browsed. It may also be limited so as to count only the number of times in which the content data is saved to the user's device, without counting the number of times of being browsed.

Not only the availability period of content data on the shared server device 1, but also the availability period of content data that is saved on the user terminal device 2 is extended. In the shared server device 1, processing that is required for the provision of this function 2 is executed by the second processing unit P2. By being configured in this manner, the availability period of content data that is browsed and downloaded many times is extended, and so can be shared and used over a long period. Conversely, since content data of which there is no browsing becomes no longer available unless its availability period is extended, content data with a low value for users is automatically weeded out. As a result, it is possible to share and use in a large number only good content data with a high value.

### (Function 3)

Function 3 also relates to extension of the availability period of a content data. This function carries out, for each user, the process of extension of the availability period only for the first time that browsing or saving is performed by one user. In the case of browsing or saving of content data being performed by a request from a user terminal device 2, the shared server device 1 extracts the user ID of the user who has browsed or saved from the user information that was reported by the command indicating that request. The extracted user ID is registered in the content data information (FIG. 2) as the already browsed user ID or already saved user ID.

In the case of browsing or saving being performed, the shared server device 1 cross-checks the user ID that was reported and the already browsed user ID or already saved user ID that are registered in the content data information, and performs a determination of whether or not that browsing or saving is the initial time. In the shared server device 1, processing that is required for the provision of this function 3 is executed by the third processing unit P3. By being configured in this manner, it is possible to prevent the value of a content data being mistakenly judged highly, or the availability period being fraudulently extended by a user, by browsing or saving of the same content data by the same user over multiple times. Thereby, it is possible to prevent actions that make the value of a content data appear to be high.

### (Function 4)

Function 4 enables changes to the availability period of a content data by an operation of the user who registered the content data. The user terminal device 2 transmits a request corresponding to this function 4 to the shared server device 1 as a command, and the shared server device 1 realizes the function 4 by executing that command by the fourth processing unit P4.

By being configured in this manner, it is possible to conclude the release in the case of wanting to conclude the release of content earlier than the initially set period, or the case of wanting to conclude the release of content data in the state of the availability period continuing to be extended. Also, for example, it is possible to enhance the desire of users to participate in the service by introducing a point system, and allowing the availability period to be extended by a user operation only in the case of having satisfied a specified condition, such as the case of having acquired predetermined points.

### (Function 5)

Function 5 changes, at the same position or the nearby area, the availability period that is originally set depending on the registration situation of the content data. The shared server device 1, at the point in time of a content data being registered, in the case of the number of already registered content data that have been registered from the same location being greater than a predetermined given number, initially sets the availability period so as become shorter. On the other hand, in the case of the number of already registered content data that have been registered from the same location being fewer than a predetermined given number, the shared server device 1 initially sets the availability period so as become longer.

In the shared server device 1, processing that is required for the provision of this function 5 is executed by the fifth processing unit P5. By being configured in this manner, it is possible to adjust the availability period by the number of already registered items at the point in time of registration of content data at the same location. Therefore, it is possible to improve the balance between the usefulness of content data and number of registered items.

### (Function 6)

Function 6 resets the availability periods of already registered content data in accordance with the latest situation, when content data is initially set based on the latest situation. In the case of the initially set availability periods of already registered content data being longer than the availability period that is initially set based on the latest situation, the shared server device 1 resets the availability periods of the already registered content data to be shorter than the availability period that is initially set based on the latest situation. However, in relation to the availability periods of already registered content data, those periods that have been extended by browsing of content data are not subject to being reset.

In the shared server 1, processing that is required for the provision of this function 6 is executed by the sixth processing unit P6. By being configured in this manner, it is possible to prevent the availability period of content data that is newly registered from being shorter than the availability periods of already viewed content data that have not been browsed.

### (Function 7)

Function 7 sets the timing for enabling browsing to other users to a release-desired time slot having a predetermined width, with the clock time that a content data was registered serving as a reference. The release-desired time slat may be automatically set, and may also be set to an arbitrary time slot that the user desires by a user setting via the user terminal device 2. Also, the release-desired time slot may also be designated, with a clock time that differs from the clock time of registration serving as a reference.

In the shared server 1, processing that is required for the provision of this function 7 is executed by the seventh processing unit P7. For example, in the case of a certain user registering at night a content data that is a shot of a night scene, it is set to be browsable during a time slot at night with the clock time at which it was registered serving as a reference. By this setting, another user comes to perform browsing of the content data in the same environment. In this way, it is possible to further deepen the degree of sharing of emotions between both parties.

### (Function 8)

The function 8 changes, for content data to be registered with its availability period designated, the availability period that is initially set depending on the registration situation of the same position or the nearby area. When the registration situation is updated, the availability period of already registered content data is also reset in accordance with the latest situation. In the case of the initially set availability periods of already registered content data being longer than the availability period that is initially set based on the registration situation at the same position or the nearby area, the availability periods of the already registered content data are reset to be shorter than the availability period that is initially set based on the registration situation. However, in relation to the availability periods of already registered content data, those periods that have been extended by browsing of the content data are not subject to being reset.

In the shared server 1, processing that is required for the provision of this function 8 is executed by the eighth processing unit P8. By being configured in this manner, it is possible to prevent the availability period of a content data that is newly registered based on the registration situation at the same position or the nearby area from being shorter than the availability periods of already registered content data that have not been browsed.

### (Function 9)

Function 9 is a function that sets a browsing desired time slot. A user who desires browsing of content data transmits via the user terminal device 2 to the shared server device 1 a command corresponding to a request that sets this browsing desired time slot. The shared browsing device 1, upon receiving this command, sets the time slot setting (setting of time slot during which browsing is desired) of the content notification desire/setting data (FIG. 3). This command is simultaneously transmitted during position information notification from the user terminal device 2 to the shared server device 1. The shared server device 1, when creating a list of content data that can be browsed, extracts the content data whose release desired time slot has been set matching the browsing desired time slot that was requested, and creates the list. Then, the shared server device 1, when the present clock time and the browsing desired time slot match, transmits the list of content data that can be browsed to the users desiring browsing (user terminal devices 2).

In the shared server 1, processing that is required for the provision of this function 9 is executed by the ninth processing unit P9. By being configured in this manner, a user who desires browsing can set the time slot that he wants to receive notifications from the shared server device 1. Also, the search scope of content data one wants to browse can be arbitrarily set with the time slot serving as a key. In this way, it is possible to prevent the undesirable effect of the user receiving notifications of unnecessary content data.

### (Function 10)

Function 10 provides restrictions on the range of release to content data to be shared. When the user has registered with the shared server device 1 a content data via the user terminal device 2, the range of positions that enable browsing of the content data is initially set in the shared server device 1 as a range that spans a predetermined range of release, from the location where the content data was registered. At the time of this initial setting, the same range of release is set for all the content data. A list of content data that can be browsed is transmitted from the shared server device 1 to the user terminal devices 2 that exist within the relevant range of release.

After this transmission, a user who desires browsing of a content data selects the content from the list of content data that can be browsed, whereby browsing of that content becomes possible. Also, it is possible to save content data that is transmitted from the shared server device 1 to the user terminal device 2 or the like that one carries. Content data that has been saved to the user terminal device 2 that the user carriers can be browsed even after that user has moved to outside of the range of release.

In the shared server 1, processing that is required for the provision of this function 10 is executed by the tenth processing unit P10. In this way, sharing of content data in broader circumstances is enabled, such as the case of being able to sufficiently convey the intent of the creator of content data or the like relating to, for example, Tokyo Tower (registered trademark) even if the position is a little way off, or the case of the user being able to readily move to the registration position of the content. Also, it is possible to prevent the generation of disadvantage for the user by content position having no relation to the present position of the user being reported in high quantity, and the lowering of the reliability of the content sharing system.

### (Function 11)

Function 11 allows a registered user of a content data, during registration of a content data, to be able to arbitrarily set the range of release of the content data (refer to FIG. 2). The range of release of a content data can be set during registration of the content data from the user terminal device 2. After registration of the content data, it is possible to change the range of release of the content by transmitting to the shared server device 1 an applicable command created by an operation of the user terminal device 2 by the registration user of the content data.

In the shared server 1, processing that is required for the provision of this function 11 is executed by the eleventh processing unit P11. By being configured in this manner, it is possible to transmit content data to users under specific conditions by narrowing the range of user positions that enable browsing. As a result, it is possible to effectively convey the intent of the user who created the content data. Also, it is possible to increase the possibility of the content data being browsed from more users by broadening the effective range of target user positions.

### (Function 12)

Function 12, during registration of a content data, initially sets automatically the range of release of the content data in accordance with the already registered number of content data in the vicinity of the position of registering the content data. Also, the function 12 performs a setting that restricts the upper limit of the range of release, when an applicable command (including a setting of the range of use) that is created with an operation of the user terminal device 2 by the user is transmitted to the shared server device 1. The range of release is set to be narrow when the density of other, already registered content data that can be browsed is high. On the other hand, the range of release is set to be wide when the density of other, already registered content data that can be browsed is low at the registration location where the content data was gathered.

In the shared server 1, processing that is required for the provision of this function 12 is executed by the twelfth processing unit P12. In this way, it is possible to prevent the selection of content data by a user becoming difficult due to the number of content data notified to the user becoming great. Also, it is possible to increase the usefulness of the present system that enables sharing of content by the notification of content that is closer to the user's situation.

### (Function 13)

Function 13, on the occasion of resetting the range of release due to a change in the registered number of content data, also resets the range of release that was initially set or the upper limit of the range of release setting of other content data that was browsable at the location where a content data serving as the opportunity of the resetting was registered or in that vicinity. In the shared server 1, processing that is required for the provision of this function 13 is executed by the thirteenth processing unit P13. By being configured in this manner, it is possible to prevent an imbalance lacking fairness in the setting conditions for the range of release of content data due to the order of registration of content data.

### (Function 14)

Function 14, in the case of the registration user arbitrarily setting the range of release at the time of registering a content data, changes the period in the initial setting of the availability period or changes the upper limit setting of the availability period, in accordance with the range of release that was set. In the case of the range of release being narrow, the availability period is set to be long. In the case of the range of release being wide, the availability period is set to be short. In the shared server 1, processing that is required for the provision of this function 14 is executed by the fourteenth processing unit P14. By being configured in this manner, imbalance in the proportion of content data that are browsed or saved that occurs due to the broadness or narrowness of the range of release is reduced. As a result, content data can be evaluated by a usefulness index. Also, the availability period can be extended or ended in accordance with the range of release (broad or narrow).

### (Function 15)

When content data that the shared server device 1 has received and that corresponds to the position information of a browsing user exists in a plurality, function 15 provides to the user content data whose range of release is narrowly set with priority over other content data. In the shared server 1, processing that is required for the provision of this function 15 is executed by the fifteenth processing unit P15. By being configured in this manner, it is possible to provide content data that is better matched to the positional state of the browsing user. As a result, it is possible to increase the usability of the present system that enables sharing of content.

### (Function 16)

For content that continues to exist over a long period due to the availability period being extended by browsing or saving, function 16 resets the range of release by the shared server device 1. As a basic operation of the shared server device 1, the range of release of content data that falls under the above is reset to be broad. However, depending on the type of the content or the setting of the registration user, the range of release of the content data is capable of being set to be broad as well as narrow.

In the shared server 1, processing that is required for the provision of this function 16 is executed by the sixteenth processing unit P16. By being configured in this manner, it is possible to have a wider spectrum of users use useful content data. In the case of the range of release of content being narrowly set, it is retained as content data whose content is popular but difficult to find. In this way, it is possible to provide methods of use that involve various effects, such as allowing people to enjoy as an event the search for this kind of content, and getting people to further heighten the connection between specific locations and content data.

### (Function 17)

Function 17 makes possible providing a constraint to the number of times that a content data can be browsed or saved by a setting of the registration user. Moreover, with function 17 the shared server device 1 resets the range of release of the content data in accordance with the remaining number of times of being browsable or savable. It is possible to broadly or narrowly reset the range of release of the content data depending on the type of content, or by the setting of the registration user.

In the shared server 1, processing that is required for the provision of this function 17 is executed by the seventeenth processing unit P17. By being configured in this manner, it is possible to provide methods of use that involve various effects such as for example providing content data with a high event nature, in accordance with the remaining number of times of the content data being browsable or savable.

### (Function 18)

A user who desires browsing of content data creates a command that sets a browsing desired location in the content notification desire/setting data, and transmits that command during the position information reporting to the shared server device 1 via the user terminal device 2. The shared server device 1, when creating a list of browsable content data, extracts the content data of which range of release that is set matches the desired location for browsing, and creates the list. After creating this list, the shared server device 1 in the case of the present location of the user terminal device 2 and the browsing desired location matching, transmits the aforementioned list stating the content data that can be browsed to that user who desires browsing.

In the shared server 1, processing that is required for the provision of this function 18 is executed by the eighteenth processing unit P18. By being configured in this manner, a user who desires browsing can arbitrarily set the location whether he wants to receive notifications or the content data he wants to browse in association with the location of the user terminal device 2. In this way, it is possible to prevent notifying a user who desires browsing of unnecessary or outdated content data.

### (Function 19)

A user who desires browsing of content data sets the browsing desired item number in the content notification desire/setting data (refer to FIG. 3), and notifies that data simultaneously during the position information notification to the shared server device 1. The shared server device 1, when creating a list of content data that can be browsed, extracts content data by the number of items of the browsing desired item number that has been set, and creates the list

In the case of the number of extracted content data that can be browsed not meeting the browsing desired item number that has been set, the shared server device 1 performs extraction of content data broadening the set range of target locations.

In the shared server 1, processing that is required for the provision of this function 19 is executed by the nineteenth processing unit P19. By being configured in this manner, a user who desires to browse can set the notification item number of content data. For this reason, even in the case of the number of extracted items being many, it is possible to receive a list of high perspicuity (a list that contains only appropriate content data). Also, in the case of the number of extracted items being few when retrieved by the initial search conditions, content data is extracted with the search conditions relaxed, and a list that meets the set notification item number is transmitted. In this way, a user who desires to browse can acquire a list of content data that meets a fixes quality standard without relying on the registration situation of content data.

### (Function 20)

Function 20 allows a registration user of content data to arbitrarily set the type of content data. The user can also arbitrarily set the type during registration of content data. After registration of content data, the registration user of the content data can update the already-set type by creating a command by operating the user terminal device 2, and transmitting that command to the shared server device 1. In the shared server 1, processing that is required for the provision of this function 20 is executed by the twentieth processing unit P20. By being configured in this manner, it is possible to raise the search hit rate during searching of content data.

### (Function 21)

A user who desires browsing of content data creates a command that sets the type of browsing desire in the content notification desire/setting data, and transmits that command during the position information notification to the shared server device 1 via the user terminal device 2. The shared server device 1, when creating a list of content data that can be browsed, extracts the content data in which the type that has been set matches the browsing desired type that has been transmitted, and creates a list. Thereafter, the shared server device 1 transmits the list of browsable content data that has been created to the user who desires browsing.

In the shared server 1, processing that is required for the provision of this function 21 is executed by the twenty-first processing unit P21. By being configured in this manner, a user who desires browsing of content data can arbitrarily set the type of content data for which he wants to receive notifications. For this reason, the user can preclude reception of notifications of unwanted content data. Also, by performing notification only to users with a desire to browse who have set the same type as the type setting that has been registered in the content data, it becomes possible to transmit content data to users of specified conditions. In this way, it is possible to more effectively transmit the intention of the user who created the content data.

### (Function 22)

Function 22 allows a user who desires browsing of content data to register any of the items that are set in the user information or a plurality of the items as items that can be registered in the content notification desire/setting data (refer to FIG. 3), in addition to the browsing desired type indicated in function 21.

In the shared server device 1, processing that is required for the provision of this function 22 is executed by the twenty-second processing unit P22. By being configured in this manner, a user who desires browsing of content data can arbitrarily set user information to content data for which he wants to receive notification. For that reason, the user can preclude reception of notifications of unwanted content data. Also, by performing notification only to users with a desire to browse who have the same settings of user information as the user information settings that have been registered in the content data, it becomes possible to transmit content data to users of specified conditions. In this way, it is possible to more effectively transmit the intention of the user who created the content data.

### (Function 23)

Function 23 displays on a map a list of browsable content data received from the shared server device 1 by means of the user terminal device 2, with the registration location (position) of the content data serving as a basis. Superimposition processing of the content data and map data may be executed by the user terminal device 2 of the browsing user. The shared server device 1 may also execute this superimposition processing, and the shared server device 1 may transmit the map data after superimposing to the user terminal device 2.

In the shared server device 1, processing that is required for the provision of this function 23 (superimposing of content data and map data) is executed by the twenty-third processing unit P23. By being configured in this manner, a user who desires browsing of content data can make content data that is displayed be content data that is superimposed with map data.

### (Function 24)

Function 24 performs the aforementioned list display on a map not only on the basis of the list of browsable content data, but also to display content data that has been registered in an arbitrary range on the basis of the present position. It may also be displayed with an arbitrary location that the browsing user has designated serving as the basis, instead of the present position. A change in the setting of the arbitrary range that serves as the aforementioned basis is made possible by a user operation. Moreover, designation of an arbitrary location that serves as the aforementioned reference can be designated by changing the map display position. It is also possible to set a landmark such as Tokyo Tower to be a reference.

In the shared server device 1, processing that is required for the provision of this function 24 is executed by the twenty-fourth processing unit P24. By being configured in this manner, a user who desires browsing of content data is capable of making content data that is displayed be content data that is superimposed with map data of a certain range from a reference that he has designated.

### (Function 25)

Function 25 enables sorting of displayed content data based on the relevance with content that is presently selected by the browsing user. The relevance with this content is determined by whether or not any one item or a plurality of items of registered content data information such as location, type, time slot, creator and the like (FIG. 2) matches or not. In the shared server device 1, processing that is required for the provision of this function 25 is executed by the twenty-fifth processing unit P25. By being configured in this manner, a user who desires browsing of content data can also browse the display of content data that is related to selected content data.

### (Function 26)

When a browsing user has designated a content data, function 26 displays associated information besides the content data itself that is related to the designated content data. For example, it displays information of stores or the like that are near the location where the designated content was registered (location where it was gathered). In the shared server device 1, processing that is required for the provision of this function 26 is executed by the twenty-sixth processing unit P26. By being configured in this manner, a user who desires to browse content data is also able to browse regional information that is related to the designated content data, or information such as stores and facilities, after display of the content data.

### (Function 27)

When a browsing-desiring user transmits to the shared server device 1 a command that designates a content data, the function 27 sets the present position of the user as the departure place, or sets the location where the content data is registered as the destination, retrieves a moving route between the departure place and the destination, and presents it to the user.

In the case of the browsing-desiring user having designated a plurality of content data, the function 27 creates a plurality of routes having differing characteristics in which each of the registration locations are passed through.

The aforementioned differing characteristics include for example the length of the moving time, and the cost of the travel expenditure.

When the browsing-desiring user additionally designates content data, the function 27 adds the location of that additionally designated content data to the destination, or creates a route that sets that location to a midway route. In the shared server device 1, processing that is required for the provision of this function 27 is executed by the twenty-seventh processing unit P27. By being configured in this manner, a user who desires browsing of content data can acquire routing information required for reaching the location where the content data has been registered.

### (Function 28)

Function 28 enables a browsing-desiring user to arbitrarily set, via the user terminal device 2, the time and date of departure during the search for a moving route by the twenty-seventh processing unit P27 of the shared server device 1. Also, the function 28 enables a browsing-desiring user also to arbitrarily set, via the user terminal device 2, the departure place. The shared server device 1 stores the time and date of departure and departure place that have been set in an internal storage area (not illustrated). In the shared server device 1, processing that is required for the provision of this function 28 is executed by the twenty-eighth processing unit P28. By being configured in this manner, the user is capable of notifying the shared server device 1 of his own time and date of departure and departure place.

### (Function 29)

Function 29 registers the moving route that the shared server device 1 has created by executing the twenty-seventh processing unit P27 in schedule management software of the user terminal device 2 on the basis of the aforementioned time and date information set during route searching. In the shared server device 1, processing that is required for the provision of this function 29 is executed by the twenty-ninth processing unit P29.

### (Function 30)

With function 30, the shared server device 1 carries movement guidance of the user, on the basis of moving route information that the shared server device 1 created by executing the twenty-seventh processing unit P27. In the shared server device 1, processing that is required for the provision of this function 30 is executed by the thirtieth processing unit P30.

### (Function 31)

With function 31, the shared server device 1 receives the location (position information) of the user terminal device 1 that is notified from the user terminal device 2 periodically or during command transmission, and stores it in the internal storage region (not illustrated). In the shared server device 1, processing that is required for the provision of this function 31 is executed by the thirty-first processing unit P31.

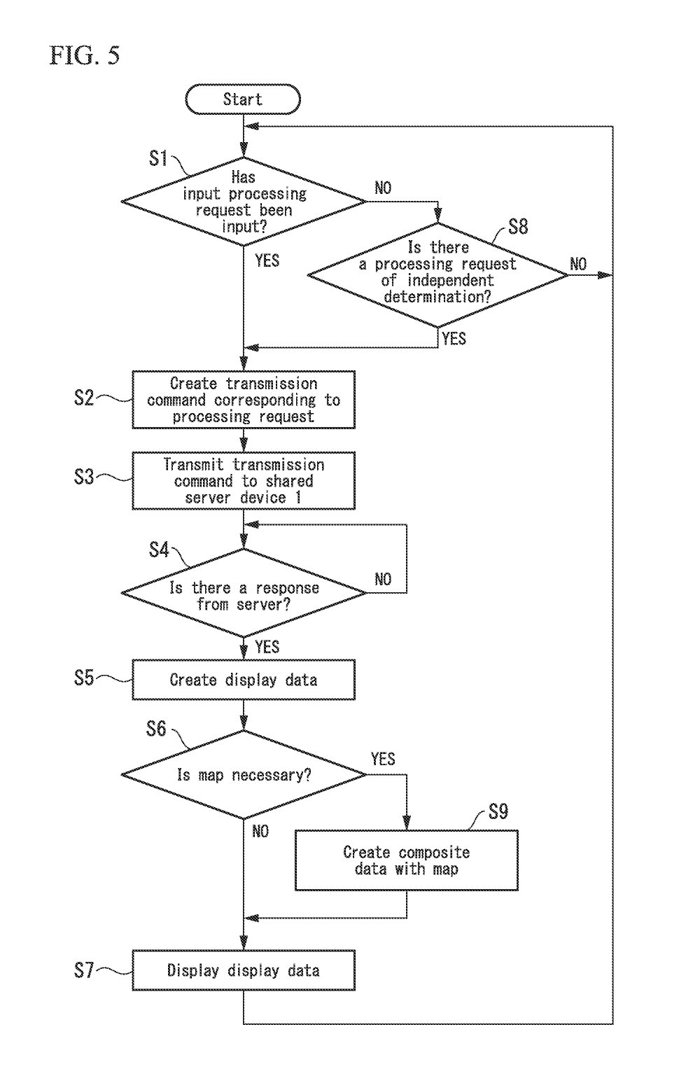

FIG. 5 is a flowchart showing the operation sequence of the user terminal device 2. Hereinbelow, the operation sequence of the user terminal device 2 shall be described using the flowchart shown in FIG. 5. First, in Step S1, the terminal control unit 20 verifies whether or not a processing request to be transmitted to the shared server device 1 has been input via the terminal input unit 23. In the case of a processing request having been input, the processing proceeds to Step S2. In the case of a processing request not having been input, the processing moves to Step S8. In Step S2, the terminal control unit 20 creates a transmission command corresponding to the processing request.

It is preferred that this command be made to correspond to the aforementioned functions (functions 1 to 31). In Step S3, the terminal control unit 20 transmits the aforesaid command to the shared server device 1 via the transmission and reception unit 21.

In Step S4, the terminal control unit 20 stands by until a response with respect to the transmission is transmitted from the shared server device 1, and upon receiving that response, the processing proceeds to Step S5. In Step S5, the terminal control unit 20 creates display data for display in the terminal display unit 24 from the reception result of the response. In Step S6, the terminal control unit 20 verifies whether or not a selection that combines map data was made for the content data that is displayed in the display data. In the case of a selection combining map data not having been made, the processing proceeds to Step S7. In the case of a selection combining map data having been made, the processing moves to Step S9.

In Step S7, the terminal control unit 20 displays the display data in the terminal display unit 24, and the processing returns to Step S1. In Step S8, the terminal control unit 20 verifies whether or not a condition to transmit a specific processing request has presently occurred by independent determination of the terminal device. In the case of a condition to transmit a specific processing request having occurred, the processing moves to Step S2. In the case of a condition to transmit a specific processing request having not occurred, the processing returns to Step S1. Here, a series of processing operations relating to this content data may be ended, and control passed to another job step. In Step S9, the terminal control unit 20 combines the map data with the content data that is to be displayed in the display data, and the processing moves to Step S7.

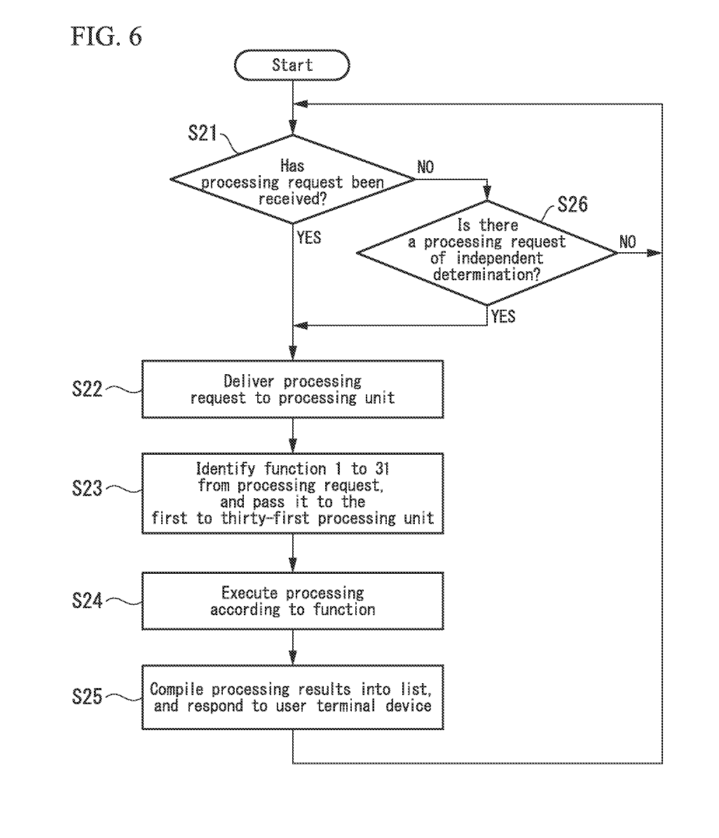

FIG. 6 is a flowchart that shows the operation sequence of the shared server device 1. Hereinbelow, the operation procedure of the shared server device 1 shall be described, using the flowchart shown in FIG. 6. First, in Step S21, the control unit 10 verifies whether or not a processing request transmitted from the user terminal device 2 has been received via the communication unit 11. In the case of having received a processing request from the user terminal device 2, the processing proceeds to Step S22. In the case of not having received a processing request from the user terminal device 2, the processing moves to Step S26. In Step S22, the control unit 10 passes the received processing request to the processing unit P0.

In Step S23, the processing unit P0 identifies the function 1˜31 from the processing request that has been delivered, and passes the delivered processing request to the first processing unit P1 to thirty-first processing unit P31 per function based on the identification result. In Step S24, the first processing unit P1 to thirty-first processing unit P31 process the delivered processing request, and return the processing results to the processing unit P0. In Step S25, the processing unit P0 compiles the processing results into a list, and transmits it as a response for the aforementioned reception to the user terminal device 2, and thereafter the processing returns to Step S21.

In Step S26, the user terminal device 2 verifies whether or not a condition to transmit a specific processing request has presently occurred by independent determination of the user terminal device. In the case of a condition to transmit a specific processing request having occurred, the processing moves to Step S22. In the case of a condition to transmit a specific processing request having not occurred, the processing returns to Step S21. Here, a series of processing operations relating to this content data may be ended, and control passed to another job step.

At least some of the processing of the constituent elements of the content sharing system according to the exemplary embodiment of the present invention is to be executed by computer control. A program that causes a computer to execute the aforementioned processing by the steps shown in the flowcharts of FIGS. 5 and 6 may be stored on a computer-readable storage medium such as semiconductor memory, CD-ROM, or magnetic tape, and distributed. The computer including in the category a micro computer, a personal computer, and a general-purpose computer may read out the program from the aforementioned recording medium and execute it.

Hereinabove, the present invention has been described referring to the aforementioned exemplary embodiment, but the present invention is not limited to the aforementioned exemplary embodiment. Various modifications that can be understood by a person skilled in the art are possible within the scope of the present invention.

This application is based upon and claims the benefit of priority from Japanese patent application No. 2011-210209, filed on Sep. 27, 2011, the disclosure of which is incorporated herein in its entirety by reference.

### INDUSTRIAL APPLICABILITY

The present invention can be applied to a content sharing system. According to a content sharing system that applies the present invention, there is the effect of being able to increase the reliability of the entire content data that is registered in a shared server device.

### (Supplementary Note 1)

The plurality of dependent processing units further include a fifteenth processing unit.

When content data that the shared server device has received and that corresponds to the position information of a browsing user exists in a plurality, the fifteenth processing unit provides to the user content data whose range of release is narrowly set with priority over other content data.

### (Supplementary Note 2)

The plurality of dependent processing units further include a sixteenth processing unit.

For content that continues to exist over a long period due to the availability period being extended by browsing or saving, the sixteenth processing unit resets the range of release.

### (Supplementary Note 3)

The plurality of dependent processing units further include a seventeenth processing unit.

The seventeenth processing unit makes possible providing a constraint to the number of times that content data can be browsed or saved by a setting of the registration user, and resets the range of release of the content data in accordance with the remaining number of times of being browsable or savable.

### (Supplementary Note 4)

The plurality of dependent processing units further include an eighteenth processing unit.

In the case of a browsing request for content data in which the browsing location is set being received from the user terminal device, and position information where the user terminal device exists being received, the eighteenth processing unit, when creating a list of browsable content data, extracts the content data in which the range of release matching the browsing desired location is set, and creates the list of content data.

### (Supplementary Note 5)

The plurality of dependent processing units further include a nineteenth processing unit.

In the case of a browsing request for content data in which the browsing desired item number is set being received from the user terminal device, and position information where the user terminal device exists being received, the nineteenth processing unit, when creating a list of browsable content data, extracts content data by the number of items of the browsing desired item number that has been set, and creates the list of content data.

### (Supplementary Note 6)

The plurality of dependent processing units further include a twentieth processing unit.

When registering a content data, the twentieth processing unit initially sets the type of content data, and resets the type that was initially set in accordance with a request from the user terminal device.

### (Supplementary Note 7)

The plurality of dependent processing units further include a twenty-first processing unit.

In the case of the browsing desired type being designated in the content data browsing request, the twenty-first processing unit extracts content data matching the browsing desired type.

### (Supplementary Note 8)

The plurality of dependent processing units further include a twenty-second processing unit.

When registering content data, the twenty-second processing unit also registers user information in addition to the browsing desired type recited in Supplementary Note 7, as content data information.

### (Supplementary Note 9)

The plurality of dependent processing units further include a twenty-third processing unit.

The twenty-third processing unit, by performing a superimposition processing a map and content data, enables the list display of a list of browsable content data transmitted to a user terminal device combined with a map on the basis of the position where each content data was registered from the terminal display unit of the user terminal device.

### (Supplementary Note 10)

The plurality of dependent processing units further include a twenty-fourth processing unit.

The twenty-fourth processing unit creates the aforementioned list display combined with a map, and in addition to browsable content data being included in the list, also targets content data that is registered in an arbitrarily specified range on the basis of the present position of the user terminal device.

### (Supplementary Note 11)

The plurality of dependent processing units further include a twenty-fifth processing unit.

The twenty-fifth processing unit performs sorting of the content data that is displayed, also including content data related with the content that is presently selected by the browsing user.

### (Supplementary Note 12)

The plurality of dependent processing units further include a twenty-sixth processing unit.

The twenty-sixth processing unit performs sorting of the content data that is displayed, also including information related with the content that is presently selected by the browsing user.

### (Supplementary Note 13)

The plurality of dependent processing units further include a twenty-seventh processing unit.

The twenty-seventh processing unit, in the case of a command that designates content data being received from the user terminal device, retrieves a moving route making the present position of the user terminal device the departure place and making the registration position of the designated content data the destination, and transmits it to the user terminal device.

### (Supplementary Note 14)

The plurality of dependent processing units further include a twenty-eighth processing unit.

The twenty-eighth processing unit, in the event of retrieval of a moving route, stores the time and date of departure included in the command, and the departure place, in an internal storage region.

### (Supplementary Note 15)

The plurality of dependent processing units further include a twenty-ninth processing unit.

The twenty-ninth processing unit transmits the retrieved moving route in a format that can be registered in schedule management software of the user terminal device, on the basis of the time and date information stored during the route retrieval.

### (Supplementary Note 16)

The plurality of dependent processing units further include a thirtieth processing unit.

The thirtieth processing unit performs moving guidance of the user who carries the user terminal device, via the user terminal device, on the basis of information of the created moving route.

### (Supplementary Note 17)

The plurality of dependent processing units further include a thirty-first processing unit.

The thirty-first processing unit receives information of the position where the user terminal device 2 exists that is notified from the user terminal device 2 periodically or during command transmission, and stores it in the internal storage region.

### REFERENCE SYMBOLS

1: Shared server device
2: User terminal device
10: Control unit
11: Communication unit
12: Database unit
13: Input unit
14: Display unit
20: Terminal control unit
21: Transmission and reception unit
22: Storage unit
23: Terminal input unit
24: Terminal display unit
30: Communication line network
P1 to P31: First to thirty-first processing units

1. A content sharing system comprising a shared server device and a user terminal device,
the shared server device comprising:
a communication unit that transmits and receives information to and from the user terminal device via a communication line network;
a database unit that stores content data serving as a shared content, accompanying information of the content data, and personal information of a user;
a control unit that determines whether a processing request is present or not, the processing request relating to processing of information including the content data stored in the database unit;
a processing unit that receives and processes the processing request from the control unit when the processing request is present; and
a plurality of dependent processing units that belong to the processing unit and execute processing corresponding to the processing request, and
the user terminal device comprising:
a transmission and reception unit that transmits and receives information to and from the shared server device via the communication network;
a terminal input unit that receives input of a processing request relating to the content data;
a terminal control unit that creates a command, transmits the command to the shared server device via the transmission and reception unit and creates display data when a processing request relating to the content data is present, the command corresponding to the processing request, the display data including the content data and related data of the content data; and
a terminal display unit that displays the display data created by the terminal control unit.

2. The content sharing system according to claim 1, wherein
the plurality of dependent processing units includes a first processing unit, and
the first processing unit registers content data, and sets an availability period of the content data when registering the content data.

3. The content sharing system according to claim 2, wherein
the plurality of dependent processing units further include a second processing unit, and
the second processing unit extends the availability period in accordance with the number of times that the content data has been browsed.

4. The content sharing system according to claim 2, wherein
the plurality of dependent processing units further include a third processing unit, and
the third processing unit limits extension of the availability period by the second processing unit to a first time that the content data is browsed or saved per user.

5. The content sharing system according to claim 2, wherein
the plurality of dependent processing units further include a fourth processing unit, and
the fourth processing unit changes the availability period of the content data.

6. The content sharing system according to claim 2, wherein
the plurality of dependent processing units further include a fifth processing unit, and
the fifth processing unit changes an initially set availability period in accordance with a registration situation of other content data that have already been registered from the same location as a position where a content data was gathered and registered, or a vicinity of the position.

7. The content sharing system according to claim 2, wherein
the plurality of dependent processing units further include a sixth processing unit, and
the sixth processing unit, when a registration situation of one content data has been updated based on a latest situation, also resets an availability period of already registered content data, based on the latest situation.

8. The content sharing system according to claim 2, wherein
the plurality of dependent processing units further include a seventh processing unit, and
the seventh processing unit, based on the clock time of registration of the content data, sets a release time slot in which a registration user of the content data desires to have other users browse the content data.

9. The content sharing system according to claim 8, wherein
the plurality of dependent processing units further include an eighth processing unit, and
the eighth processing unit resets the availability period in accordance with a registration situation of other content data already registered from the same location as a position where the content data in which the release time slot has been set was gathered and registered.

10. The content sharing system according to claim 2, wherein
the plurality of dependent processing units further include a ninth processing unit, and
the ninth processing unit, in a case of a browsing desired time slot being designated in a browsing request for content data, extracts content data whose a release time slot matches the browsing desired time slot, as a list of browsable content data.

11. The content sharing system according to claim 2, wherein
the plurality of dependent processing units further include a tenth processing unit, and
the tenth processing unit, when registering the content data, limits a range of release of the content data to a predetermined range of release on based on a position where the user terminal device performed the registration.

12. The content sharing system according to claim 2, wherein
the plurality of dependent processing units further include an eleventh processing unit, and
the eleventh processing unit sets a range of release of the content data by a registration processing request for the content data or a setting request for a range of release of the content data, from the user terminal device.

13. The content sharing system according to claim 2, wherein
the plurality of dependent processing units further include a twelfth processing unit, and
the twelfth processing unit, when registering the content data, initially sets a range of release of the content data in accordance with a registration situation of other content data that have already been registered from the same location as a position where the content data was gathered and registered, or a vicinity of the position, and the twelfth processing unit resets an upper limit of the initially set range of release in accordance with a request from the user terminal device.

14. The content sharing system according to claim 13, wherein
the plurality of dependent processing units further include a thirteenth processing unit, and
the thirteenth processing unit, on an occasion of resetting of the range of release, resets a range of initially set release, or an upper limit of the range of release, also for other content data that is browsable at the position where the content in which the range of release is to be reset was gathered and registered or in the vicinity of the position.

15. The content sharing system according to claim 13, wherein
the plurality of dependent processing units further include a fourteenth processing unit, and
the fourteenth processing unit changes the availability period that was initially set or changes setting of the upper limit of the availability period, in accordance with the range of release that was set.
